(19) United States
(12) Patent Application Publication
(10) Pub. No.: US 2004/0223882 A1
(43) Pub. Date: Nov. 11, 2004

(54) Micro-plasma sensor system

(76) Inventors: Ulrich Bonne, Hopkins, MN (US); Michael L. Rhodes, Richfield, MN (US); Barrett E. Cole, Bloomington, MN (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/749,863

(22) Filed: Dec. 31, 2003

Related U.S. Application Data
(63) Continuation-in-part of application No. 10/672,483, filed on Sep. 26, 2003.
Application No. 10/672,483 is a continuation-in-part of application No. 10/671,930, filed on Sep. 26, 2003.
(60) Provisional application No. 60/440,108, filed on Jan. 15, 2003.
(60) Provisional application No. 60/500,821, filed on Sep. 4, 2003.
(60) Provisional application No. 60/414,211, filed on Sep. 27, 2002.

(51) Int. Cl. G01N 21/17

(52) U.S. Cl. 422/82.05; 422/82.11

(57) ABSTRACT

A micro plasma sensor system having a glow discharge gap. A fluid to be sensed may be brought into the vicinity of the discharge at the gap. Emission light from the discharge may be coupled to an optical spectrum analyzer for determining properties of the fluid. The coupling may include a window and particulate-matter-sensing electrodes proximate to the discharge gap. Window cleanliness and electrode electrical isolation may be maintained by the discharge. The optical analyzer may have individual bandpass filters for two or more optical channels to optical detectors, a Fabry-Perot filter in front of a set of optical detectors, or a grating or prism which disperses emission light at various angles according to wavelength to an array of light detectors. The optical detectors may output electrical signals to be processed.

The present application claims priority under 35 U.S.C. § 119(e)(1) to co-pending U.S. Provisional Patent Application No. 60/440,108, filed Jan. 15, 2003, and entitled “PHASED-III SENSOR”, wherein such document is incorporated herein by reference. The present application also claims priority under 35 U.S.C. § 119(e)(1) to co-pending U.S. Provisional Patent Application No. 60/500,821, filed Sep. 4, 2003, and entitled “PHASED V, VI SENSOR SYSTEM”, wherein such document is incorporated herein by reference. The present application claims priority as a continuation-in-part to co-pending U.S. Nonprovisional application Ser. No. 10/672,483, filed Sep. 26, 2003, and entitled “PHASED MICRO ANALYZER V, VI”, which claims the benefit of U.S. Provisional Application No. 60/414,211, filed Sep. 27, 2002, wherein the co-pending U.S. Nonprovisional application Ser. No. 10/672,483 is incorporated herein by reference. The present application claims priority as a continuation-in-part to co-pending U.S. Nonprovisional application Ser. No. 10/671,930, filed Sep. 26, 2003, and entitled “PHASED MICRO ANALYZER III, IIIA”.

### BACKGROUND

The present invention pertains to detection of fluids. Particularly, the invention pertains to plasma structures, and more particularly to the application of the structures as sensors for the identification and quantification of fluid components. The term “fluid” may be used as a generic term that includes gases and liquids as species. For instance, air, gas, water and oil are fluids.

Aspects of structures and processes related to fluid analyzers may be disclosed in U.S. Pat. No. 6,393,894 B1, issued May 28, 2002, to Ulrich Bonne et al., and entitled “Gas Sensor with Phased Heaters for Increased Sensitivity,” which is incorporated herein by reference.

Presently available fluid composition analyzers may be selective and sensitive but lack the capability to identify the one or more components of a sample mixture with unknown components, besides being generally bulky and costly. The state-of-the-art combination analyzers GC-GC and GC-MS (gas chromatograph—mass spectrometer) approach the desirable combination of selectivity, sensitivity and smartness, yet are bulky, costly, slow and unsuitable for battery-powered applications. In GC-AED (gas chromatograph—atomic emission detector), the AED alone uses more than 100 watts, uses water cooling, has greater than 10 MHz microwave discharges and are costly.

Micro gas chromatography (μGC) detectors should be fast responding (<1 ms), sensitive but not selectively to specific compounds, of simple construction and low-cost, compact, and low-power (˜mW). Presently available or conceived μGC detectors are either not very sensitive, such as thermal conductivity sensors (≧10 to 100 ppm of analyte); too selective to specific compounds such as fluorescence and electron-capture detectors; relatively high-cost such as the typical price tags in year 2003 of about $600, $3000 and upwards for many GC detectors; prone to drift due to soiled optics as micro-discharge devices (MDDs) monitored via spectral analysis; or relatively high-power such as the AEDs (atomic emission detectors) which consume over 100 W.

Related art NOₓ (and to a large extent CO, NH₃, SOₓ, VOC) sensors to monitor and/or control such emissions from (internal and external) combustion processes are not suited for unsupervised, on-board combustion systems. They are either too costly (chemiluminescence (CL) and even multi-layered ZrO₂ sensors), too bulky (CL and IR absorption if the detection limit is to be near 5 ppm), too fragile (CL and IR long-path cell) or not stable enough (e.g., SnO₂/WO₃ and wet-electrochemical sensors). Another problem of these optical sensors is their high maintenance cost, as needed to keep the optics clean.

Related art optical gas sensors (NO, CO, NH₃, SO₂, CH₄, . . . , CWA) based on spectral analysis of glow discharge emission are not suited for compact, low-cost, wide-wavelength-range packaged systems because they lack a rugged, low-cost and compact multi-channel analyzer. They are either too costly and bulky (e.g., FTIR or conventional dispersive spectrometers, or even new, compact palm-top-size spectrometers), too fragile (spectrometers), not transmissive enough (narrow band-pass filters need fairly good collimation of light to avoid band broadening, i.e., need low aperture operation resulting in low-light transmission) or not versatile enough (small number of channels with individual, narrow band-pass filters). Also, a problem of these optical sensors is their high maintenance cost, such as keeping their optics clean.

### SUMMARY

The optical spectral/molecular emission-based NO, and the like, sensor system is low power, low-mass and compact (the emissive glow discharge plasma is only 10-100 microns in diameter), can have its plasma at 1100 degrees C., is low-cost, rugged (no precision optical alignments needed) and has stability. With adequate air filtering, operation may occur without noble gas purging, with high temperature plasma self-cleaning, signal processing and advantageous packaging.

Spectral analysis of the MDD emission may rely on a scanning, narrow band-pass, MEMS Fabry-Perot (FP) filter, i.e., it is compact, versatile (having many channels), highly effective light intensity (despite the high mirror-etalon reflectivity if many (100-1000) MDDs are operated in parallel) and low-maintenance because the FP-filter operates in a sealed environment, and the only other optical surface exposed to sample gas is self-cleaned by the MDD.

### BRIEF DESCRIPTION OF THE DRAWING

FIG. 1 shows a micro discharge device optically coupled to an optical multi-channel analyzer based on light inputs through interference filters;

FIG. 2 is a close view of a discharge gap to optical fiber interface;

FIG. 3 shows a discharge gap housing attached to an exhaust pipe;

FIG. 4 shows a micro discharge device optically coupled to an optical, single-channel, wavelength-modulated analyzer based on a scanning Fabry-Perot filter;

FIG. 5 is a close view of the Fabry-Perot type analyzer;

FIG. 6 shows a micro discharge device optically coupled to a spectrometer;

FIG. 7 is a graph of the relative intensity versus wavelength for a spectral emission of a glow discharge with a mixture of NO in N₂;

FIG. 8 is a table of angular sensitivity data for materials of various refractive indexes;

FIG. 9 is a table of Fabry-Perot filter design parameters for wavelength modulation in gas sensing; and

FIG. 10 is a graph of a wavelength scan of a Fabry-Perot filter.

### DESCRIPTION

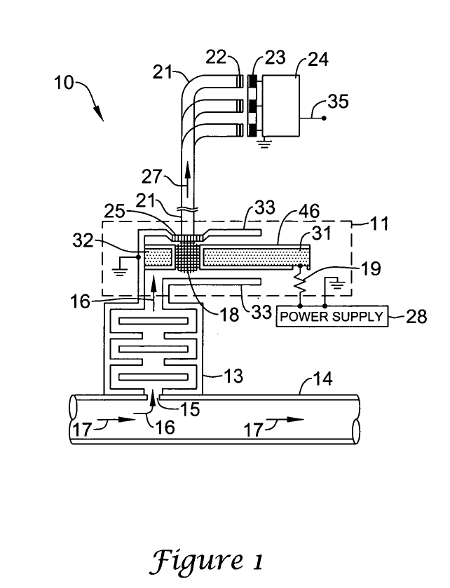

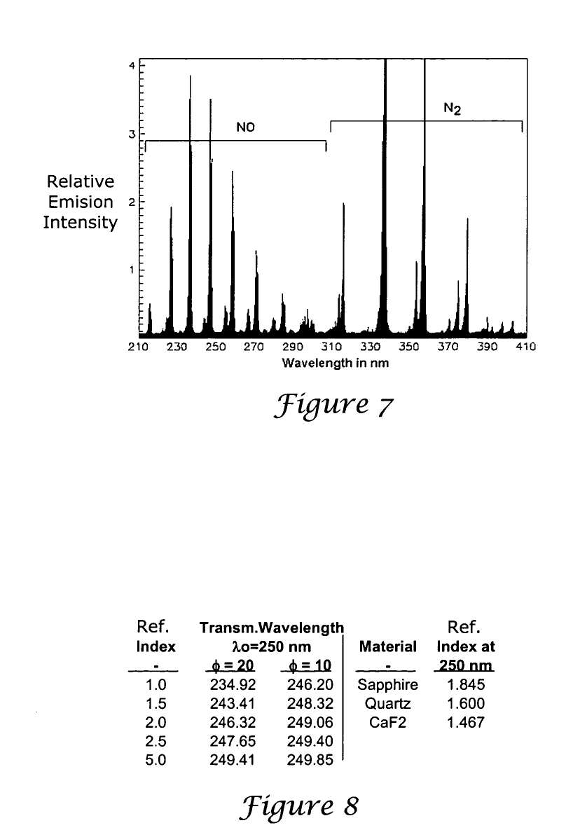

A micro discharge device 11 (MDD) is shown in systems 10, 20 and 30 of FIGS. 1, 4 and 6, respectively. Device 11 may have one electrode 31 and another electrode 32 with ends facing each other to form a gap for providing a micro glow discharge 18. The gap may be enclosed in a glass tube or hollow pipe 33. Device 11 may have a soot electrode that may be kept clean of soot build-up. Device 11 may have a UV/visible spectrum as shown in a graph of FIG. 7. That graph shows relative intensity versus wavelength in nm for a spectral emission of a glow discharge using 22.9 ppm of NO in N₂ in an environment of 700 Torr. To date, mostly noble gases (N₂, Ar, He) have been used to study the characteristics of such micro discharges.

The glow discharge device 11 may be a part of system 10 as illustrated in FIG. 1. It may consist of the building blocks outlined in FIG. 1. System 10 may have a sample gas filter 13 connected to an exhaust pipe 14 at an opening 15. Filter 13 may remove PM (particulate matter) and condensables from an exhaust sample 16 from exhaust 17. Then sample 16 may flow into the vicinity of glow discharge 18 situated in a glass pipe 33 and affect the emission of the discharge according to the composition of sample 16. Light 27 from discharge 18 may propagate through fibers 21, filters 22 and be converted to electrical signals by detectors 23. The electrical signals may go to amplifiers and microprocessor 24 to be processed into output signals indicating the composition of sample 16.

Glow discharge 18 may be about 10 to 500 microns in diameter. The discharge may be started and sustained with about a 100 to 400 volt AC/DC power supply in series with about a 1 to 15 Meg-ohm resistor 19, which generates the spectral band emissions shown in FIG. 7 for the composition as noted above. Power supply 28 may be connected to metal electrode 31 via resistor 19 and to metal electrode 32. The glow discharge 18 may be started and maintained between electrodes 31 and 32 due to the presence of the voltage from the power supply 28. Electrodes 31 and 32 may be coated with an insulative material 46 such as, for example, MgO. Other materials may be used.

Optical fibers 21 may be optically connected to the glow discharge device 11 at optical interface or window 25 and be used with filters 22 for NO at 247.2 or 258.8±1.4 nm, a reference N₂ at 336.9 or 357.5±2 nm, other band pass filters for O₂, CH, C₂, CO, SO₂, as needed, and off-NO and N₂ at 251.2±2.5 and 362.3±4 nm, respectively. The optical filters 22 may be deposited at the flattened ends of the optical fibers 21, which would have narrow band pass half-width of about three nm (to match the ˜2.8 nm NO emission half bandwidth (HBW)) to 20 nm. Also shown in FIG. 1 are photo detectors 23 (Si-diode, Si-photo-transistor, sensitized for UV) proximate to filters 22. Outputs of the photo detectors 23 may go to amplifiers and signal processor 24 which may output a referenced signal about NO, VOC, CO, SOₓ, or the like in the sample 16, with a ppm indication signal at output 35 of amplifiers and processor 24.

For operation, device 11 may be designed to force the micro discharge 18 to glow close to and impinge on the side of the observation fibers 21, as shown in FIG. 1. The mild discharge 18 sputter action may be intended to maintain a high level of optical transmission of the window 25 in FIG. 1, despite the known tendency of combustion exhaust gases to darken optical surfaces they come in contact with, in a short time. However, there may be cleaning action on the window 25 by the plasma of discharge 18. Also, the electrodes may be kept clean.

Significant elements of the system 10 are the optical fiber-cables 21 with deposited filters 22 at their ends with the other ends facing the glow discharge 18, and the PM filter or filters 13. Materials may include those that are low-cost, temperature resistant (not a high need due to the intermediate PM filter 13, which may cool sample gas temperatures) and of a high index, in order to minimize the angular sensitivity of the band-pass filters 22, which may be given by a few exemplary filters described in terms of peak transmission wavelength, λ_{∘}, vs. deviation angle, φ, of the incident beam from one parallel to the fiber axis:

λ_{φ}=λ_{∘}(nₑ²−sin ²_{φ})^{0.5}/nₑ.

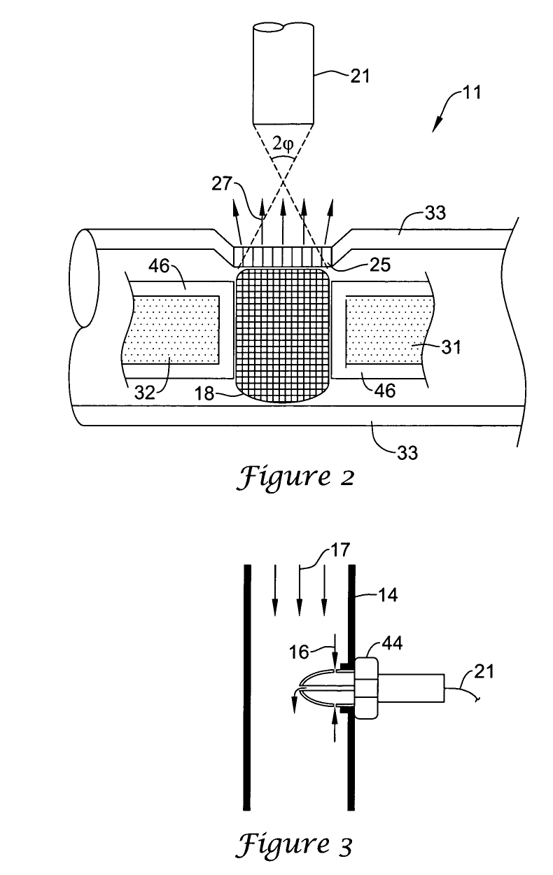

This influence of the index, n, on λ_{φ} is illustrated by the data in the table of FIG. 8, for λ_{∘}=250 nm and φ=10° and 20°. The highest index of the listed materials, i.e., sapphire with n=1.845 at 250 nm still would cause a shift by about 5 nm for (p=20°, but only by ˜1.5 nm for φ=10° (see FIG. 2 for positioning the fiber 21 at some distance from window 25, so that φ≦10°), which may be one approach. Another one would be based on using a wider band-pass filter that covers all bands of NO with a half-width of 23 nm: λ_{∘}=247.2±12 nm; the down-side of this approach is an approximately 5× loss in NO sensitivity and a greater probability for cross-sensitivity to other gases that might have spectral emissions in that same band. If this approach is chosen, the manufacturability, cost of the filter and its shifts due to angular and temperature variations may become less critical.

The concern about the influence of temperature is based on the fact that λ_{∘} tends to shift to longer wavelength with increasing temperature (and vice versa) due to the thermal expansion of the coating materials, as suggested here.

λ_{T}=λ_{∘}+αΔT, with α˜0.01−0.2 nm/deg. C.

This may shift λ_{∘} by 10 nm for only a 100 degree C. rise in temperature and α=0.1 nm/deg. C., if the above information is correct. One would expect a value for α′˜10⁻⁶−10⁻⁵/deg. C. or α˜2·10⁻⁴−2·10⁻³ nm/deg. C.

Manufacturing costs may be low due to inexpensive parts and assembly as preliminarily noted here. The parts may include one grounded and one insulated wire in a tube 33 (glass, quartz, sapphire) to support the plasma in a spark-plug-like environmental package 44 as shown in FIG. 3, optical fibers 21 with deposited interference filters 22, two to four Si photo-diodes 23, a power supply 28 with a DC-to-DC converter (100-400V), an amplifier 24 for the photo-diodes 23, and a microprocessor 24 for signal processing and logic functions, a PM filter 13 and sample gas flow channels. Also, automated assembly and calibration may be implemented to reduce costs. A very little scrap would be expected from the making of the present micro-plasma sensor system 10.

NOₓ sensing via MDD is known and has been done before by Caviton, Inc. and maybe others, with nobel gas purge in one microchannel leading to the MDD, but has not been done without such purge, directing only the sample gas to the MDD. Features of the sensing system in FIG. 1 include: operating the MDD without noble purge gas; using MDD for window cleaning and for maintaining electrode isolation in an MDD detector application; observing no spectral emissions in the IR; designing a co-planar MDD as source another MDD as detector; and co-locating a spectral-emissive and, for example, a soot sensor in one package.

There may be self-cleaning of the optical surface 33 on the MDD side and facing the optical fiber, i.e., window 25 of FIGS. 1, 2, 4 and 6. No noble gas purge cleaning is needed. The invention of the sensor system 10 may include use of plasma discharge device 11 for exhaust gas composition measurements, but without noble-gas purge; use of the plasma discharge 18 to keep the observation window clean, by plasma-etching away any combustion-product deposits such as condensable tars and carbon-soot; use of the same plasma discharge to maintain the required electrical insulation of the non-grounded micro-discharge electrode (see magnified view of one example electrode tip in FIG. 2); use of a plasma discharge to maintain the required electrical insulation of the non-grounded electrode by additional periodic power-cleaning cycles, which may or may not cause a pause in the measurement and the self-check cycle; use of an associated PM filter 13 to cool and clean the sample gases after soot sensing but before spectral MDD sensing, in order to minimize temperature-induced wavelength shifts in the bandpass filter; use of smart positioning between the end of the optical fiber and the photodiode to detect only optical fiber light components of small angles, as required by the chosen bandpass filter width; and use of the same or a similar glow discharge 18 to maintain cleanliness and (more importantly) the required electrical isolation of the soot-sensor electrodes (not shown FIGS. 1-3).

Additional design features related to quasi state-of-the-art PM filters may include mechanisms for overcoming concerns about water condensation (removal or preferably made harmless via sensor heating), and packaging the soot sensor electrode into this same housing to reduce cost, total bulkiness and plasma-cleaning synergies.

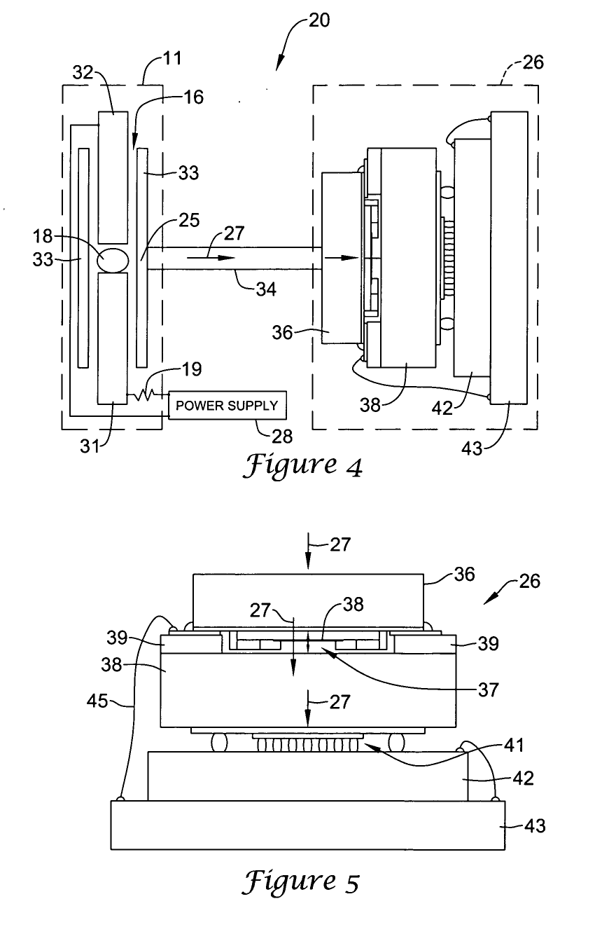

Another implementation of glow discharge device 11 is system 20 shown in FIG. 4. A scanning Fabry-Perot filter 26, shown with more detail in FIG. 5, may be adapted to the band pass and wavelength range desired for the desired application. A PM filtered gas 16 may enter the glow discharge device 11 and enter the vicinity of the glow discharge 18. Discharge 18 may be enclosed in a glass capillary or pipe 33. The discharge 18 may be started and sustained by a voltage of about 100 to 400 volts from power supply 28 connected to electrodes 31 and 32 from which the discharge emanates. A light pipe 34 or other optical conveyance mechanism may be optically connected to the glass pipe 33 at a window 25 to carry the light 27 of the discharge to a non-dispersive, Fabry-Perot, narrow band-pass, scanning filter 26. Filter 26 may provide a spectral analysis of the light 27.

Filter 26 may be a Fabry-Perot (FP) based MEMS spectrometer for MDD emission analysis. Light pipe 34 may be optically coupled to a Pyrex or quartz window 36 of filter 26. Window 36 may be a UV blocking filter. As shown in FIG. 5, light 27 may propagate through window 36 into a FP cavity having about a 5 mil (25 micron) high cavity 37 with an etalon 38 that may move up or down to adjust cavity 37 to a particular frequency of interest to be passed through or filtered out. The movement of etalon 38 may be effected with a control signal line 45. This adjustment may determine the wavelength of light 27 to be passed or blocked. Cavity 37 may be formed with a sapphire base 38 and window 36 with an environmental hermetic seal 39 formed around the perimeter of cavity 37 to provide space in the cavity and a seal between window 36 and sapphire base 38 to seal the cavity from its environment. The portion of light 27 that passes through cavity 37 may be sensed by an array of detectors 41. The detectors 41 may be in a form of a linear or another kind of array, and be composed of AlGaN/GaN or other appropriate or workable material. Detectors 41 may convert the light signals 27 into electrical signals that are input into a readout integrated circuit 42. Circuit 42 may have a processor to analyze the signals to provide information about the sample gas 16. A package 43 may be utilized overall to enclose at least a portion of filter 26. The output of circuit 42 may provide a spectral analysis of light 27. This analysis may imply the composition of the sampled gas 16 passing through the glow discharge 18.

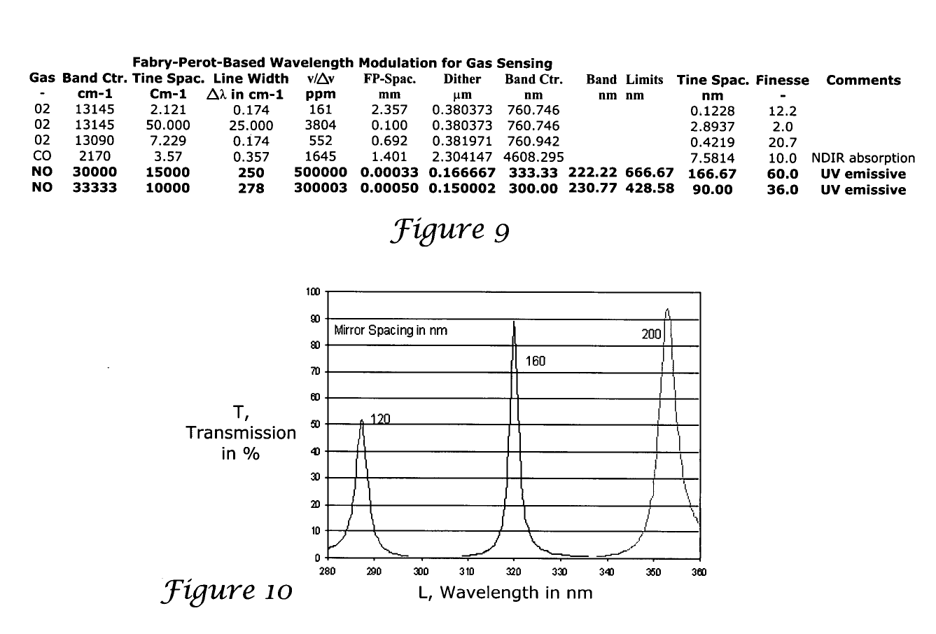

During operation of filter 26, one may envision that only one (and not many in parallel) tine (=transmission peak of the Fabry-Perot comb-filter) of about 1 nm to 3 nm half width does the scanning, while the others may be designed to be outside of the scanning area. The table in FIG. 9 shows parameters of FP-based wavelength modulation for gas sensing. It gives some examples of the FP-filter design parameters needed to accomplish this application of the MMD as well as for other applications (CO and O₂ sensing). The parameters shown in FIG. 9 may include the gas sensed, band center, tine spacing, line width, ν/Δν, FP spacing, dither, band limits and finesse, among other parameters.

As the FP-spacing layer 38 of cavity 37 is dithered by a given amount, the Δλ line-width band-pass may scan around the band center by ± the tine spacing in cm⁻¹ or nm, or between the shown band limits in nm. The computed Fabry-Perot band width and spectral position (and including the response of the AlGaN detector array) for the last row in the table in FIG. 9 may be shown in FIG. 10 for the minimum, center and maximum wavelength position, respectively, with the corresponding etalon mirror spacing. FIG. 10 shows percentage of transmission versus wavelength for a wavelength scan of a MEMS FP filter. The wavelength position may be limited in the computed example in FIG. 10 by the available wavelength sensitivity range of the AlGaN detectors, which is about 290 to 360 nm.

Features of system 20 in FIG. 4 may be taken as exemplary emission bands for which the scanning FP-filter and detector 26 would need to achieve the following measurement performance (λ and ±Δλ/2): with NO at 247.2 or 258.8±1.4 nm, reference N₂ at 336.9 or 357.5±2 nm, and off-NO and N₂ at and 251.2±2.5 and 362.3±4 nm, respectively.

One may consider the known influence of f-number on achievable FP-filter 26 finesse, which may be even more constraining here. However, one may design the FP-filter 26 to be less sensitive to temperature-induced drift of the wavelength band-pass, but also limited by the temperature range rating of the discharge device 11.

The sensor system 20 may be based on the following: plasma micro discharge device (MDD) for gas sensing via spectral emission analysis of unknown gas mixture samples, using non-dispersive (Fabry-Perot-based) spectral analysis (rather than a dispersive spectrometric analysis) or interference filters; the Fabry-Perot (FP) wavelength scan performed via a MEMS-based FP-filter design; new use of the above assembly (of MDD and FP-based spectral filter) as high speed gas chromatography peak (GC) analyzer, and independently, as stand alone gas sensor for NO, O₂, SO₂, . . . in one unit; new use of above assembly (MDD+FP+GC), whereby the GC is a μGC or a μGC-μGC or a μGC-μGC-MDD gas mixture analyzer, of low probability for false positives, P_{fp}; and a design of the MDD in which the discharge self-cleans the window 25 and operates without a noble gas purge.

Successful implementation of systems 10 and 20 may enable the achievement of low false positive probabilities when using this discharge device 11 and detector as part of a GC-CG-MDD micro-analyzer, as represented by PHASED.

The sensing systems 10 and 20 may offer the following advantages over previously proposed or offered exhaust gas composition sensing systems. They are more compact, rugged and lower cost than chemiluminescence-based sensor systems. They are more stable than metal-oxide or catalyst-based and conventional optical sensor systems. They are less energy consuming than ZrO₂-based NO and O₂ sensor systems and more temperature change tolerant than other ZrO₂—NO/O₂ sensor systems. They are more manufacturable than multi-layer ZrO₂, metal oxide or catalyst based sensor systems. They are compatible and easy to integrate with a soot sensor system.

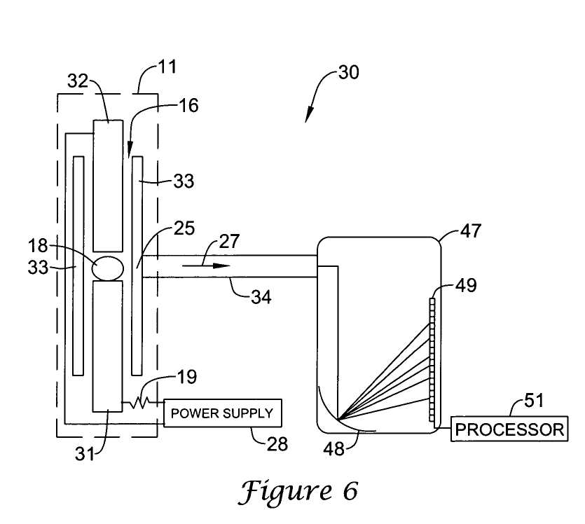

System 30 of FIG. 6 may have a discharge gap device 11, like that of systems 10 and 20, except that light 27 may be conveyed via a light pipe 34 to a dispersive spectrometer 47 for analysis of the emission of the discharge 18 to reveal information about the sample gas 16. Light 27 may be conveyed to an optical grating 48 for reflection of various wavelengths of light 27 to various pixels, respectively, of a CCD light detecting array 49. Electrical signals from array 49 may go to a processor 51 for analysis and interpretation.

Although the invention has been described with respect to at least one illustrative embodiment, many variations and modifications will become apparent to those skilled in the art upon reading the present specification. It is therefore the intention that the appended claims be interpreted as broadly as possible in view of the prior art to include all such variations and modifications.

What is claimed is:

1. A sensor system comprising:
a first electrode;
a second electrode proximate to the first electrode to form a gap between the first and second electrodes;
a light waveguide having a first end proximate to the gap; and
a filter proximate to a second end of the light waveguide; and

2. The system of claim 1, further comprising:
an optical enclosure encompassing the first and second electrodes; and
wherein the first end of the light waveguide is proximate to the optical enclosure.

3. The system of claim 2, wherein the gap is an electrical discharge gap.

4. The system of claim 3, further comprising a soot sensing electrode susceptible to soot build-up and is kept clean by the electrical discharge gap.

5. The system of claim 3, wherein the electrical discharge gap is proximate to the optical enclosure.

6. The system of claim 5, wherein the electrical discharge gap can generate light and keep clean an optical surface of the optical enclosure proximate to the first end of the light waveguide.

7. The system of claim 6, wherein the filter is a bandpass filter for at least one wavelength.

8. The system of claim 7, further comprising a light intensity indicator connected to the filter.

9. The system of claim 8, further comprising an enclosure encompassing the first and second electrodes.

10. The system of claim 9, wherein the gap can provide a micro glow discharge within and about the gap.

11. The system of claim 10, wherein the filter comprises at least one interference filter.

12. The system of claim 10, wherein the filter is a Fabry-Perot interference filter.

13. The system of claim 10, further comprising a particulate matter filter connected to an input of the enclosure.

14. The system of claim 13, wherein the particulate matter filter is connected to a combustion exhaust system.

15. The system of claim 13, further comprising a spark-plug-like package wherein the package encloses the particulate matter filter, the first and second electrodes, and the first end of the light waveguide.

16. The system of claim 15, wherein the spark-plug-like package is connected to an exhaust system.

17. A sensor system comprising:
a first electrode;
a second electrode proximate to the first electrode to form a gap between the first and second electrodes;
a light waveguide having a first end optically connected to the gap and having a second end; and
a spectrometer optically connected to the second end of the light waveguide.

18. The system of claim 17, wherein the gap is an electrical discharge gap.

19. The system of claim 18, wherein the gap is a micro discharge gap.

20. The system of claim 19, wherein the gap is a micro glow discharge gap.

21. The system of claim 18, wherein the spectrometer comprises an optical grating optically coupled to the second end of the light waveguide.

22. The system of claim 21, wherein the spectrometer further comprises a light detector optically coupled to the optical grating.

23. The system of claim 22, further comprising a particulate matter filter having an output proximate to the gap.

24. The system of claim 23, wherein the particulate matter filter has an input connected to an exhaust system.

25. A means for sensing comprising:
means for providing an electrical discharge;
means for coupling a fluid to a vicinity of the means for providing an electrical discharge; and
means for analyzing light optically coupled to the means for providing an electrical discharge.

26. The means of claim 25, wherein the electrical discharge is a micro glow discharge.

27. The means of claim 26, wherein the means for analyzing light comprises a spectrometer.

28. The means of claim 26, wherein the means for analyzing light comprises a Fabry-Perot filter.

29. The means of claim 26, wherein the means for analyzing light comprises:
at least one filter;
at least one light detector coupled to the at least one filter; and
a processor connected to the at least one light detector.

30. A method for detecting a fluid, comprising:
providing an electrical discharge;
conveying a fluid to the electrical discharge; and
analyzing light from the electrical discharge.

31. The method of claim 30, wherein the electrical discharge is a micro discharge.

32. The method of claim 31, wherein the analyzing light comprises detecting intensities of various wavelengths.

33. The method of claim 32, wherein the electrical discharge is a glow discharge.

34. The method of claim 32, wherein the detecting intensities of various wavelengths comprises frequency modulation via an active Fabry-Perot filter.

35. The method of claim 32, wherein the detecting intensities of various wavelengths is performed in part with a spectrometer.

36. The method of claim 32, wherein the fluid effectively does not comprise a nobel gas.

37. The method of claim 36, wherein the fluid is of a group including indoor air, outdoor air, industrial process fluid, combustion exhaust, fluid having particulate matter which may obscure light from the electrical discharge to a light detecting device of the analyzing light from the electrical discharge.

38. The method of claim 37, further comprising analyzing the fluid for its chemical composition.

39. The method of claim 38, further comprising placing the electrical discharge in a manner to emit light and keep clean an optical surface needed for light transmission to the light detecting device.

40. The system of claim 1, wherein the filter is an optical filter positioned between the gap and a photo-detector on one or both ends of the light waveguide which is two or more optical fibers.

41. The system of claim 4, wherein the soot sensing electrode susceptible to soot build-up is kept clean by a discharge plasma of the gap or by a second gap, wherein the discharge plasma is positioned upstream of the filter and otherwise the discharge plasma for a spectral analysis is positioned down stream of the filter.

42. The system of claim 17, wherein the spectrometer is a spectral analysis device having a plurality of optical filters and an optical spectrometer optically connected to the second end of the light waveguide.
